(19) United States
(12) Patent Application Publication
(10) Pub. No.: US 2007/0096046 A1
(43) Pub. Date: May 3, 2007

(54) Multifunctional spout chuck

(76) Inventor: Mark Dubois, Boynton Beach, FL (US)

Correspondence Address: John Christopher;Christopher & Weisberg, P.A., Suite 2040, 200 East Las Olas Boulevard, Fort Lauderdale, FL, 33301, US

(21) Appl. No.: 11/263,705

(22) Filed: Nov. 1, 2005

(51) Int. Cl. F16K 35/00

(52) U.S. Cl. 251/90

(57) ABSTRACT

The present invention provides a chuck for a container having a valve assembly biased towards a primary closed position, where the valve assembly can be actuated to a secondary open position for dispensing fluid. The chuck includes a fixation element which is engageable with the valve assembly of the container, as well as a biasing element which actuates the valve assembly of the container into the secondary open position in order to dispense fluid, allowing hands-free operation of the container. The fixation element may include a first and second prong positionable proximate the valve assembly of the container, while the biasing element may include a third prong having a protrusion for overcoming the predisposed primary closed position of the valve assembly.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to a device for biasing a valve for a liquid container spout in the open position.

### BACKGROUND OF THE INVENTION

There are many situations where someone would like to attend to personal hygiene, such as washing their hands or face, in a location where there is no running water. Often, the location where a person would most like to clean-up is the place least likely to have wash facilities. For example, outdoorsmen, outdoor workers, and athletes like to clean-up in the field or on a job site. In the absence of water, individuals resort to wiping their hands or face, for example, with a dry cloth, such as clothing, scrubbing with small pre-moistened paper towels, or waterless hand sanitizers and the like. However, nothing really substitutes for a stream of water for washing purposes.

Known portable hand wash stations often include bulky containers that are difficult to carry. Some provide an electric pump mechanism to aid in dispensing the fluid in the container and a basin in which water is retained. However, the absence of available water is likely coupled with the absence of an electrical source, making the use of an electrical pump impossible without a portable generator in many situations; and a basin, while nice to have, really isn't necessary for washing purposes. Moreover, inclusion of a pump, power cord, basin and other accessories adds greatly to cost as well as to weight.

Instead of the electric hand wash station, the simple and omnipresent “Igloo” or other similar container is commonly used to provide water for drinking and for washing. This is not surprising, as a substantial percentage of people engaged in outdoor activities bring drinking water in a container with them. While the Igloo and similar containers are very well suited to dispensing water into a drinking cup, they are not particularly well suited for dispensing water for washing purposes. Specifically, the valve associated with the dispensing spout in many known water containers includes a valve element or “button” that is biased towards a closed state. The button is placed into an open state by pressing the button to overcome a modest biasing force, thereby allowing the water in the container to be dispensed. So long as the button is pressed down, the valve remains open and provides a continuous flow of water. Unfortunately, to be able to wash your hands by rubbing them together with soap in the customary manner, a second person is required to press the button for water flow.

In view of the above limitations, it would be desirable to make better use of existing water containers. More specifically, it would be desirable to transform existing water coolers into efficient, functional hand washing stations by providing an accessory that would allow for “hands free” operation of a container valve.

### SUMMARY OF THE INVENTION

An accessory device hereinafter referred to as a “spout chuck” is provided for known water containers to facilitate “hands-free” operation of the container, thereby providing a washing station. Known fluid containers often have a valve assembly in which a button is biased towards a primary closed position which may be overcome by the application of marginal force in order to move the button to a secondary open position to dispense fluid. In an exemplary embodiment, the spout chuck has a body portion that includes a fixation element engageable with the valve assembly of the container, in order to position the spout chuck proximate to the valve assembly. The spout chuck further includes a biasing element capable of actuating the valve assembly, causing the button to move from the primary closed position to the secondary open position, thereby allowing fluid to be dispensed.

In addition, the spout chuck of the present invention may also be used with a container having a valve assembly including a movable stopper that is biased to a first closed position in which fluid is prevented from being dispensed. To allow fluid dispersion, the stopper is moved to a secondary open position, typically by depressing a button linked to the stopper. The spout chuck can include a shaped aperture which can engage the stopper of the valve assembly as to prevent the stopper from obstructing fluid flow out of the container when the button is no longer depressed, resulting in the hands-free operation of the container.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a prior art container having a valve-controlled water spout;

FIG. 2 is a perspective view of the prior art container of FIG. 1 having an alternative valve configuration;

FIG. 2A is a cross-sectional view of the valve of FIG. 2;

FIG. 3 is a front view of an embodiment of a spout chuck in accordance with the present invention;

FIG. 4 is a side view of the spout chuck of FIG. 3;

FIG. 5 is a rear view of the spout chuck in FIG. 3;

FIG. 6 is a perspective view of an exemplary use of the present invention in operation with a prior art container;

FIG. 6A is a side view of the present invention in operation with a prior art container;

FIG. 7 is a detail perspective view of the present invention in operation with a second prior art container;

FIG. 8 is a perspective view of the present invention hanging from a hook.

### DETAILED DESCRIPTION OF THE INVENTION

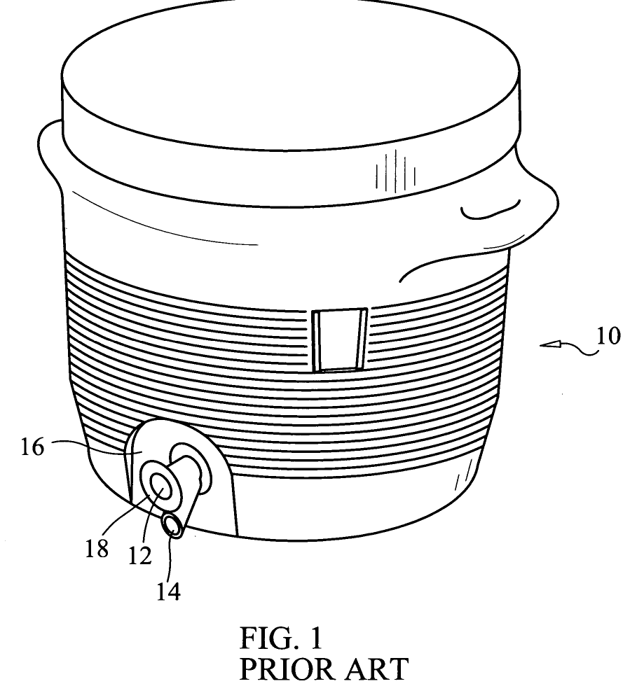

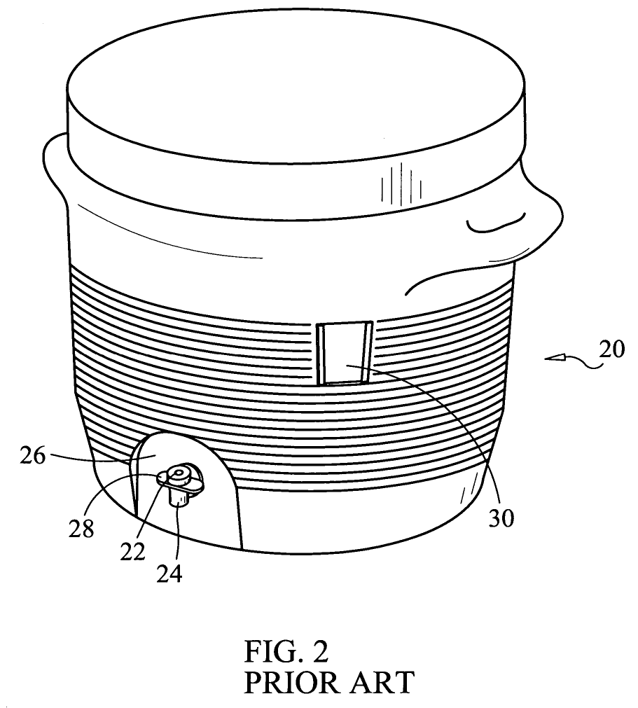

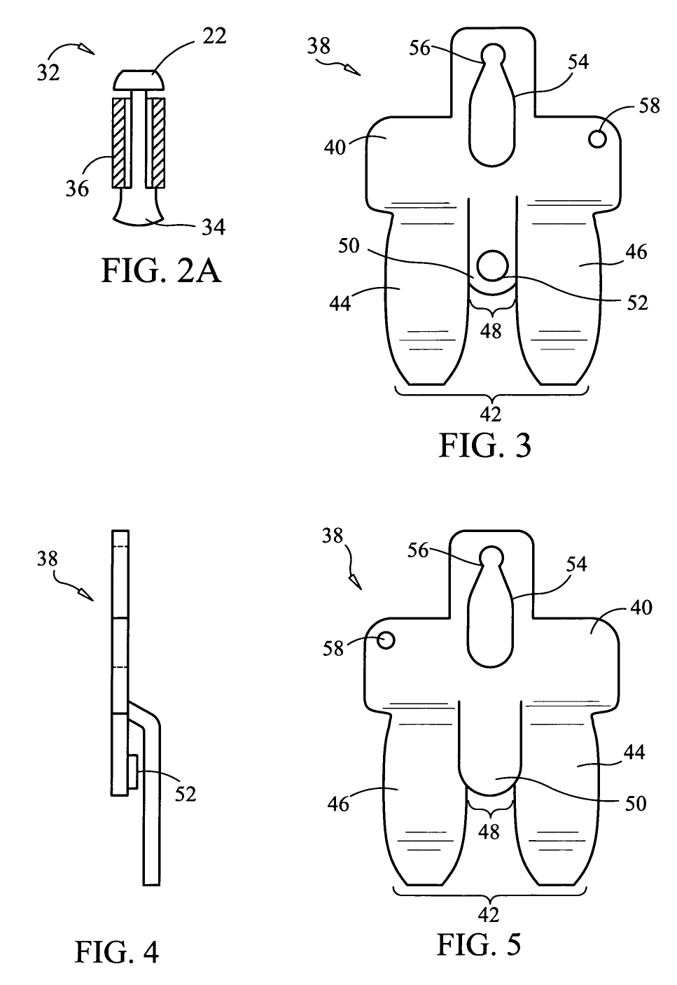

Prior art containers are shown in FIG. 1 and FIG. 2. FIG. 1 illustrates a water container 10 having a valve operated by a button 12. For this type of container, the button 12 is biased towards a primary closed position where the valve prevents fluid in the container from being dispensed. The valve can be opened by applying a modest force to the button, thereby causing the button to depress inward to a secondary open position. Subsequently, as the button is depressed towards the secondary open position, the valve of the container is opened and fluid is dispensed from a spout 14. The container may further include a recess 16 which surrounds the button 12 and provides easier access to the spout 14 and the button 12. Moreover, a flange 18 may surround the button 12 to provide a supporting structure to aid in depressing the button.

FIG. 2 illustrates a second container 20 similar to that of FIG. 1, except the second container 20 has an alternative fluid dispensing mechanism. For this particular type of container, a button 22 is biased towards a primary closed position in which fluid is prevented form escaping the container. Similarly to the container described above, fluid can be dispensed by applying a modest force to the button 22, thereby causing the button 22 to depress downward to a secondary open position. Subsequently, as the button 22 is depressed downward towards the secondary open position, the valve of the container is opened and fluid is dispensed from a spout 24. In addition, a recess 26 also may surround the button 22 to provide access to the spout 24 and the button 22, and a flange 28 may further surround the button 22 to aid in depressing the button. Furthermore, either container in FIG. 1 or FIG. 2 may include a bracket 30 which can receive a rack for holding paper cups or other accessories (not shown).

A cross-sectional detail of the mechanism for dispensing water from the second container 20 is found in FIG. 2A. As shown, a valve assembly 32 includes the button 22 connected to a movable stopper 34. Movement of the stopper 34 is restricted by a generally cylindrical wall 36, and the button 22 is biased towards a closed position in which the stopper 34 abuts the cylindrical wall 36 and prevents fluid from being dispensed. As the button 22 is depressed, the stopper 34 descends downward and fluid may be dispensed from the container 20 through the spacing between the stopper 34 and the cylindrical wall 36.

Now referring to FIGS. 3 through 5, the present invention provides a spout chuck 38. The spout chuck 38 generally defines a body portion 40. In addition, the spout chuck 38 defines a fixation element 42 that provides for the coupling or affixation of the spout chuck 38 proximate to a valve or dispenser assembly of a fluid container. The fixation element 42 extends from the body portion 40, where the fixation element 42 may include a first prong 44 and a second prong 46 coplanar to and laterally spaced from the first prong 44. The spout chuck 38 further defines a biasing element 48 extending from the body portion 40, which can be in the form of a third prong 50 offset from the first and second prongs, where the third prong 50 includes a raised protrusion 52 that extends towards the first and second prongs of the fixation element 42. The biasing element 48 provides for the sufficient application of force or resistance as to actuate a valve or button assembly of a fluid container such that the button or valve assembly is moved from a primarily closed position to a secondary position where fluid is dispensed. The third prong 50 may be situated such that although it may be parallel to the first and second prongs, it is not coplanar with either of the first or second prongs.

The spout chuck 38 of the present invention can further include a shaped aperture 54 in the body portion 40. The shaped aperture 54 defines a first end and a second end, wherein the width of aperture decreases to form a neck 56 in between the first and second ends. Furthermore, the spout chuck 38 can include a second aperture 58, which can aid in hanging the spout chuck 38 from a hook or hanging feature on a container.

As can be seen from FIG. 4, the spout chuck 38 is a relatively thin apparatus, and can be manufactured from a wide range of plastics or other suitable material. Moreover, the spout chuck 38 may be constructed in a singular form, for example, through injection molding or the like, or alternatively be assembled from individual components in order to create the embodiments and functional characteristics as described.

The spout chuck 38 can be constructed as to provide the first and second prongs of the fixation element 42 with a flexible resiliency with respect to the body portion 40 of the spout chuck 38. Similarly, the biasing element 48 may have a flexible resiliency with respect to the body portion 40 of the spout chuck 38, which can ease the positioning of the spout chuck 38 proximate to a valve assembly of a fluid container. In addition, the biasing element 48 as well as the first and second prongs of the fixation element 42 may be elastically deformable with respect to each other to allow for the temporary increase of spacing between the biasing element 48 and the fixation element 42, which further can aid in positioning the spout chuck. As such, the biasing element 48 and the fixation element 42 can be pulled apart somewhat and then, subsequently, the spacing between the two elements can resiliently decrease to the original positioning.

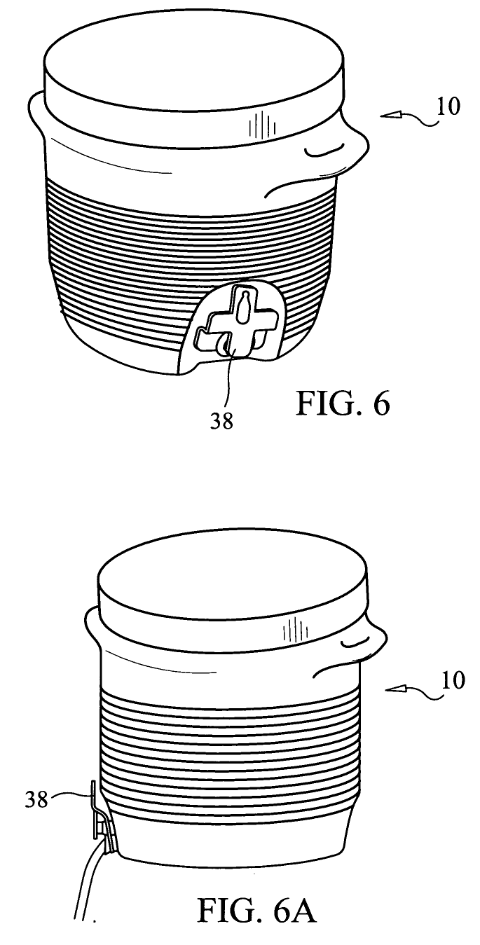

In an exemplary use of the present invention, the spout chuck 38 can be implemented with a container 10 having a depressible button 12 for regulating fluid flow, as previously described. As shown in FIGS. 6 and 6A, the spout chuck 38 is positioned about the button 12 and the flange 18 surrounding the button 12 such that the two prongs of the fixation element 42 abut the rear side of the flange 18. Subsequently, the third prong 50 and the protrusion 52 of the biasing element 48 are directly in contact with the button 12 of the container 10. As the two prongs of the fixation element 42 are further positioned about the flange 18 and button 12, the protrusion 52 of the biasing element 48 places pressure on the button 12 in order to depress the button inward towards the secondary open position. With the spout chuck 38 coupled about the button 12 and flange 18, the button 12 is now held in the secondary open position and fluid is dispensed until the spout chuck 38 is removed, thereby allowing “hands free” operation of the container.

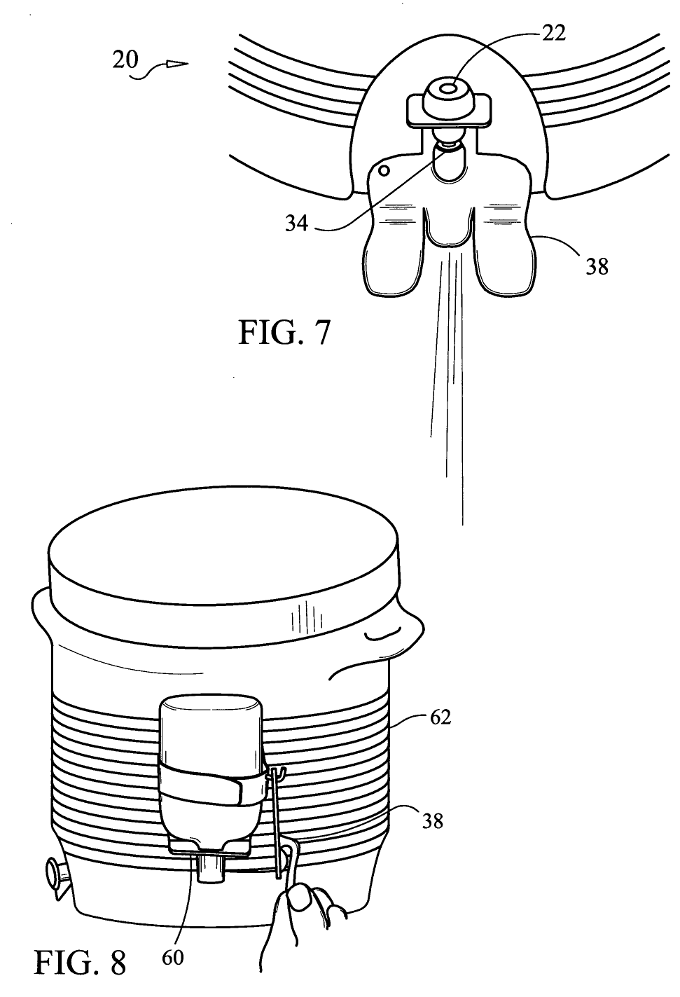

Now referring to FIG. 7, in an exemplary operation of the spout chuck 38 with a container 20 having a movable stopper 34 as described above, the button 22 of the container 20 is depressed, causing the stopper 34 to descend from the cylindrical wall 36 of the valve assembly 32. The spout chuck 38 is then positioned such that the stopper 34 passes through the shaped aperture 54 of the spout chuck 38. The spout chuck 38 can then be positioned such that the neck 56 of the shaped circumscribes a portion of the stopper 34, thereby interjecting the body portion 40 of the spout chuck 38 in between the stopper 34 and the cylindrical wall 36. Once the button 22 is no longer depressed, the body portion 40 of the spout chuck 38 prevents the stopper 34 from closing and abutting the cylindrical wall 36, thereby allowing fluid to be dispensed without the application of manual pressure to the button 22.

Now referring to FIG. 8, when the spout chuck 38 is no longer needed to aid in fluid dispensing from a container, the spout chuck 38 may be hung from a dispenser 60 for an ancillary liquid container attached to the container. The dispenser 60 may include a rack attachable to the bracket 30 on the container. In addition, the dispenser 60 may include a hook 62 that fits the second aperture 58 in the spout chuck 38 so that the spout chuck 38 may hang from or otherwise be complementarily coupled to the dispenser.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A chuck for a fluid container, comprising:
a body portion;
a first prong and a second prong extending from the body portion, wherein the first prong is laterally spaced from the second prong; and
a biasing element extending from the body portion located substantially between the first and second prongs.

2. The chuck according to claim 1, wherein the biasing element includes a third prong that is not coplanar with either of the first and second prongs.

3. The chuck according to claim 2, wherein the biasing element further includes a protrusion extending towards the first and second prongs.

4. The chuck according to claim 1, wherein the body portion defines a shaped aperture.

5. The chuck according to claim 4, wherein the shaped aperture defines a neck.

6. The chuck according to claim 4, wherein the body portion further defines a second aperture.

7. The chuck according to claim 1, wherein the chuck is constructed from plastic.

8. The chuck according to claim 1, wherein the first and second prongs are resiliently flexible with respect to the body portion.

9. The chuck according to claim 1, wherein the biasing element is resiliently flexible with respect to the body portion.

10. The chuck according to claim 1, wherein the biasing element is elastically deformable to increase the distance between at least a portion of the biasing element and at least a portion of the first and second prongs.

11. The chuck according to claim 1, wherein the first and second prongs are elastically deformable to increase the distance between at least a portion of the biasing element and at least a portion of the first and second prongs.

12. In combination with a liquid container having a valve assembly biased to a primary closed position and having a secondary open position, a chuck comprising:
a body portion;
a fixation element extending from the body portion, wherein the fixation element is engageable with the valve assembly; and
a biasing element extending from the body portion, the biasing element able to actuate the valve assembly to the secondary open position.

13. The combination according to claim 12, wherein the fixation element includes a first prong and a second prong laterally spaced from the first prong.

14. The combination according to claim 13, wherein the first and second prong are coplanar.

15. The combination according to claim 14, wherein the biasing element includes a third prong that is not coplanar with either of the first and second prongs.

16. The combination according to claim 15, wherein the biasing element further includes a protrusion extending towards the first and second prongs.

17. The combination according to claim 12, wherein the body portion defines a shaped aperture.

18. The combination according to claim 17, wherein the shaped aperture defines a neck.

19. The combination according to claim 12, wherein the body portion defines a second aperture.

20. A chuck for a liquid container, comprising:
a body portion defining a shaped aperture, the shaped aperture defining a neck;
a fixation element extending from the body portion, wherein the fixation element defines a first prong and a second prong laterally spaced from the first prong, wherein the first and second prongs are resiliently flexible with respect to the body portion; and
a biasing element extending from the body portion located substantially between the first and second prongs, wherein the biasing element defines a third prong that is not coplanar with either of the first and second prongs, wherein the third prong is resiliently flexible with respect to the body portion, and wherein the third prong includes a protrusion extending towards the first and second prong.
